(19) United States
(12) Patent Application Publication
(10) Pub. No.: US 2015/0113937 A1
(43) Pub. Date: Apr. 30, 2015

(54) ENHANCED FIRE PROTECTION FOR FUEL MANIFOLD

(71) Applicant: Delavan Inc., DesMoines, IA (US)

(72) Inventor: Daniel Edward Bleeker, Ankeny, IA (US)

(73) Assignee: Delavan Inc., DesMoines, IA (US)

(21) Appl. No.: 14/190,794

(22) Filed: Feb. 26, 2014

Related U.S. Application Data
(60) Provisional application No. 61/896,384, filed on Oct. 28, 2013.

(51) Int. Cl. F02C 7/22

(52) U.S. Cl. CPC F02C 7/222
USPC 60/39.091; 29/888.012

(57) ABSTRACT

One embodiment includes a fuel manifold segment for supplying fuel to a fuel injector. The fuel manifold segment contains a fuel line surrounded by a first firesleeve. A pigtail line connects to the fuel line. A connector on the pigtail line connects to a fuel injector inlet fitting. A second firesleeve surrounds the first firesleeve. A cuff surrounds the pigtail line, portion of first firesleeve, and portion of fuel line to which the pigtail line is connected. A boot then surrounds the connector.

### BACKGROUND

The present embodiments relate generally to fuel manifolds and, more particularly, to fire protection of fuel manifolds for gas turbine engines under high temperature conditions.

Fuel manifolds in gas turbine engines are used to distribute fuel from a fuel control system to fuel injectors affixed around the engine case. The fuel injectors spray fuel into the combustor of the engine where high temperatures ignite the fuel and create energy. Since a fuel manifold contains fuel at all times during engine operation, there is a special interest in ensuring a fuel manifold is adequately protected in the event of a fire inside the engine. Fuel manifold fire protection systems have been developed to prevent fuel in the manifold from leaking in the event of a fire outside the engine for a period of time.

The Federal Aviation Administration (FAA), for example, sets testing standards for passenger aircraft fuel systems to ensure their safe operation under prolonged exposure to flames. The FAA requires gas turbine engine fuel manifolds, on passenger aircraft, pass a five minute fire resistance test at a minimum flow condition. This test uses a flame calibration of 2000° F. minimum average temperature. Fuel manifold fire protection systems were typically designed by trial and error fire testing at an average temperature lower than 2000° F. minimum average temperature. As a result, these fire protection systems fail at 2000° F. minimum average temperature. Moreover, fuel manifold fire protection systems that may be capable of withstanding 2000° F. minimum average temperature at a minimum flow condition make inspection of the fuel manifold extremely complicated as these fuel manifold fire protection systems tend to be one complete, cohesive blanket. Inspection currently necessitates the use of special tools, is time-consuming, and may ruin the fire protection system in the process, requiring replacement.

### SUMMARY

One embodiment includes a fuel manifold segment for supplying fuel to a fuel injector. The fuel manifold segment contains a fuel line surrounded by a first firesleeve. A pigtail line connects to the fuel line. A connector on the pigtail line connects to a fuel injector inlet fitting. A second firesleeve surrounds the first firesleeve. A cuff surrounds the pigtail line, a portion of the first firesleeve, and a portion of the fuel line to which the pigtail line is connected. A boot then surrounds the connector.

Another embodiment includes a method of providing fire protection on a fuel manifold. It includes fitting a boot around a connector on a pigtail line for connecting to a fuel injector inlet fitting. The boot is secured in place with a clamp.

### BRIEF DESCRIPTION OF THE DRAWINGS

FIG. 1 is a side-elevational view of an installed fuel manifold fire protection system on a gas turbine engine.

FIG. 2 is a cut-away perspective view of a fuel manifold segment of FIG. 1.

FIG. 3a is a side-elevational view of an exposed connector joined to a fuel injector inlet fitting.

FIG. 3b is a perspective view of the connector of FIG. 3a with a boot being fitted around the connector.

FIG. 3c is a perspective view of the connector of FIG. 3a with a boot cover.

FIG. 4a is a perspective view, of another embodiment, of a portion of a fuel manifold segment without a cuff.

FIG. 4b is a perspective view of the same fuel manifold segment portion of FIG. 4a with a custom cuff molded on.

### DETAILED DESCRIPTION

Fuel manifolds are present in various types of engines and serve to distribute fuel inside an engine. One embodiment includes a fire protection system for a fuel manifold, particularly a fuel manifold for a gas turbine engine. However, embodiments can be used on all types of fuel manifolds in various types of engines and power units. Fuel manifold fire protection is increased as more exposed metal of the fuel manifold is covered with fire protective material, as this prevents the fuel manifold from absorbing additional heat. One embodiment provides improved fuel manifold fire resistance by affording more fuel manifold metal coverage, while at the same time allowing for easy in service fuel manifold inspection without destroying the fuel manifold's fire protection. This embodiment includes, among other components, a second firesleeve, a cuff, and a boot.

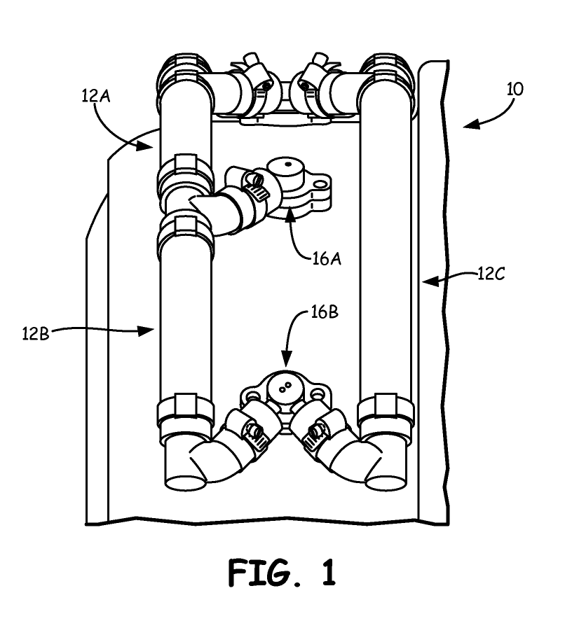

FIG. 1 shows a side-elevational view of one embodiment of fuel manifold fire protection system 10 installed on a gas turbine engine. However, this is only an illustrative embodiment, as fuel manifold fire protection system 10 can be used on any fuel manifold which needs fire protection from high temperatures. Fuel manifold fire protection system 10 includes fuel manifold segments 12A, 12B, and 12C, and fuel injector tops 16A and 16B. Fuel manifold segment 12A connects the fuel supply (not shown) to fuel injector top 16A and fuel manifold segment 12B. Fuel manifold segment 12B connects fuel manifold segment 12A to fuel injector top 16B. Fuel manifold segment 12C connects the fuel supply to fuel injector top 16B.

Fuel manifold fire protection system 10 in FIG. 1, therefore, is made up of a plurality of fuel manifold segments, with each fuel manifold segment extending between fuel injector tops circumferentially and in close proximity to the engine case. Fuel manifold fire protection system 10 functions to distribute fuel from the fuel supply to each fuel injector. Additionally, fuel manifold fire protection system 10 provides a fire protection system for a fuel manifold which is capable of withstanding a fire at least at 2000° F. minimum average temperature at a very low flow rate in the fuel line for a period of at least 5 minutes. The fire protection system shown in FIG. 1 is a fire protection solution for low or very low flow rates. Low or very low flow rates vary depending on the size of the engine and diameter of the fuel line. For example, fuel manifold fire protection system 10 has passed AS 1055 fire testing procedures for flexible hoses which requires a dash 3 size ( 3/16″) hose to contain a flow rate of 1 ID², or 0.019 gal/min, and a dash 6 size ( 6/16″ or ⅜″) hose to contain a flow rate of 1 ID² or 0.098 gal/min. However, low or very low flow rates can include rates nominally above zero, such as 0.001 gal/min in the fuel line.

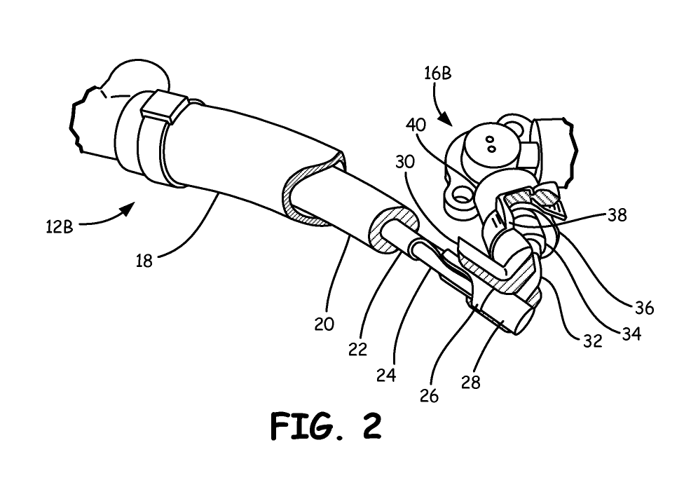

FIG. 2 shows a perspective cut-away view of fuel manifold segment 12B. Fuel manifold segment 12B includes second firesleeve 18, first firesleeve 20, reinforcing layer 22 over fuel line 24, crimp collar 26 and hose insert 28 at the end of fuel line 24, pigtail line 32, cuff 30, connector 34, boot 36, clamp 38, and fuel injector inlet fitting 40. Fuel manifold segment 12B serves to distribute fuel to fuel injector top 16B.

Second firesleeve 18 surrounds first firesleeve 20 and a portion of cuff 30 and is secured in place over and around first firesleeve 20 and a portion of cuff 30. First firesleeve 20 is integrally extruded and surrounds reinforcing layer 22. Reinforcing layer 22 surrounds fuel line 24 and is attached to hose insert 28 by crimp collar 26. Pigtail line 32 is connected to hose insert 28 and provides an internal fuel passage therethrough between fuel line 24 and fuel injector top 16B. Cuff 30 is molded over pigtail line 32, a portion of fuel line 24 to which pigtail line 32 is connected, and a portion of first firesleeve 20. Cuff 30 ends after covering a portion of first firesleeve 20, and second firesleeve 18 then surrounds the remaining portion of first firesleeve 20, the point where cuff 30 meets first firesleeve 20, and a portion of cuff 30. Connector 34 has a hydraulic fitting next to it and serves to join fuel injector inlet fitting 40 to pigtail line 32 allowing fuel to pass into fuel injector. Boot 36 is fitted around and surrounds connector 34 and is secured in place with clamp 38.

Second firesleeve 18 can be made up of any type of fire protective material, including fiber reinforced silicone rubber or AS 1072 fiberglass silicone rubber material available from AB Technology Group, Ogdensburg, N.Y. Second firesleeve 18 is an additional layer that surrounds the first firesleeve and a portion of cuff 30, rather than a layer within the first firesleeve. Second firesleeve 18 can be secured in place in various ways, including where second firesleeve 18 is molded, spirally wrapped, or clamped in place. Any type of clamp can be used to secure second firesleeve 18 in place, including metal band clamps on each end of second firesleeve 18 as shown in FIG. 1.

First firesleeve 20 can be made, for example, of a silicone rubber material. Reinforcing layer 22 provides support for fuel line 24 and can be, for instance, wire braid as present in FIG. 2. Fuel line 24 can be, for example, a polytetrafluoroethylene (PTFE) liner. Cuff 30 is of a custom size and shape fit to the particular size fuel manifold segment it is being used on and can be made of silicone rubber material. Connector 34 can be, for example, a nut as shown in FIG. 2 which screws onto fuel injector inlet fitting 40.

Boot 36 is purpose built for fire protection and can be made of any fire resistant material, including a fiber reinforced rubber material. Boot 36 can be a split cylinder with an overlap fitted in place by wrapping boot 36 around connector 34 such that the split cylinder overlaps at a point, then securing boot 36 in place with a clamp. The clamp can be, for example, a screw adjustable clamp as shown in FIG. 1, a band clamp, or a metal Panduit clamp. Alternatively, boot 36 can be a continuous cylinder (with no overlap) put in place prior to the connector being secured to the fuel injector inlet fitting 40, then slid back to allow the connector to be secured, and finally slid back in place and clamped after the connector is secured.

Fuel manifold segment 12B, with the use of second firesleeve 18, cuff 30, and boot 36, among its other components, leaves little to no fuel manifold metal exposed and, therefore, prevents the fuel manifold from absorbing additional heat. This in turn allows fuel manifold segment 12B to withstand a greater temperature without failure. For example, fuel manifold segment 12B can withstand fire at 2000° F. minimum average temperature at a very low flow rate in the fuel line for a period of at least 5 minutes.

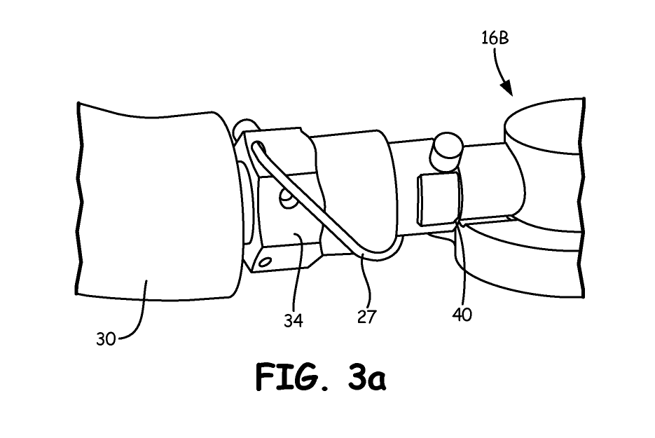

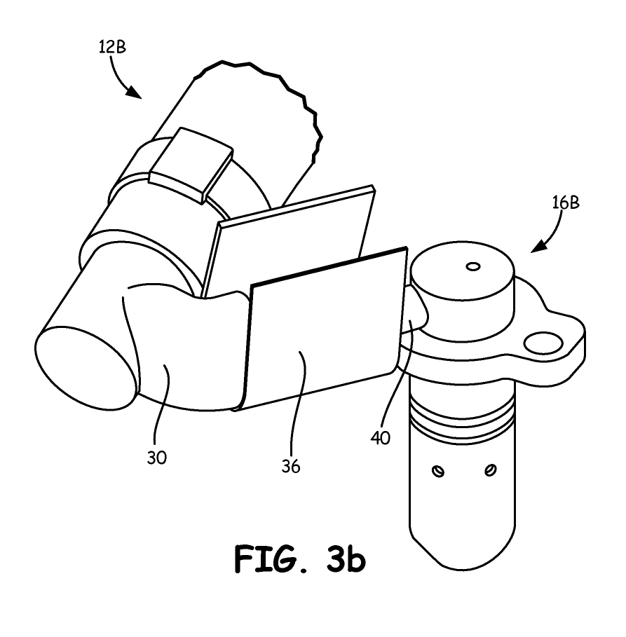

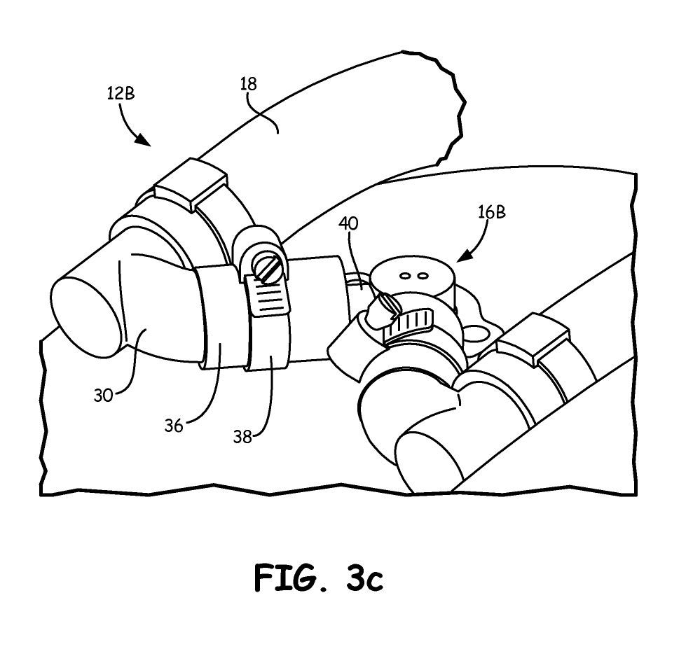

FIG. 3a shows a side-elevational view of exposed connector 34 joined to fuel injector inlet fitting 40 of fuel injector top 16B. Cuff 30 is molded onto the fuel manifold segment and provides coverage up until the pigtail line (not shown) meets connector 34. Connector 34 is made up of a nut and a hydraulic fitting which mates with the fuel injector inlet fitting 40. Also present is antirotation thread locking safety cable 27, which is installed for safety to prevent connector 34 from rotating and becoming disconnected from fuel injector inlet fitting 40, resulting in a fuel leak.

When no boot is present, connector metal is exposed and as a result the fuel manifold segment of FIG. 3a may fail at a lower temperature than otherwise would be the case if fire protection was present. For this reason, a boot is fitted around connector 34 to provide fire protection to the fuel manifold segment in this location.

FIG. 3b is a perspective view of fuel manifold segment 12B, fuel injector top 16B, and connector (not shown) of FIG. 3a with boot 36 being fitted around the connector. Boot 36 is similar to that detailed for FIG. 2. Also present is cuff 30 molded onto a portion of fuel manifold segment 12B, and fuel injector inlet fitting 40. In this embodiment, boot 36 is a split cylinder with an overlap. Boot 36 is fitted around the connector by wrapping the split cylinder to cover the connector such that the split cylinder overlaps when the connector is covered.

FIG. 3c shows a perspective view of fuel manifold segment 12B, fuel injector top 16B, and connector (not shown) of FIG. 3a with boot 36 from FIG. 3b fitted around the connector. Boot 36 is secured in place by clamp 38. Also present in FIG. 3c is second firesleeve 18, cuff 30 molded onto fuel manifold segment 12B, and fuel injector inlet fitting 40.

In the embodiment shown in FIG. 3c, clamp 38 is a screw adjustable clamp. However, clamp 38 can also be, for example, a band clamp or a metal Panduit clamp. The screw adjustable clamp 38 in FIG. 3c can be removed simply by using a common tool, such as a screwdriver. This allows boot 36 to be removed from fuel manifold segment 12B in service quickly and easily to inspect the underlying connection for a leak, without having to procure special tools to remove or destroy the entire fuel manifold segment fire protection system and the added time and costs which come with doing so. This enables any person with a screwdriver and a flashlight to remove boot 36 for inspection. After removing boot 36 and inspecting the connection, boot 36 can then again be fitted around the connector and secured in place with clamp 38 using a common tool. If boot 36 is instead a continuous cylinder (no overlap), it can be slid out of the way to expose the connector to allow for inspection, and slid back into place and clamped after inspection. In addition to allowing for easy and quick inspection, the ability to reuse boot 36 and clamp 38 saves on replacement costs.

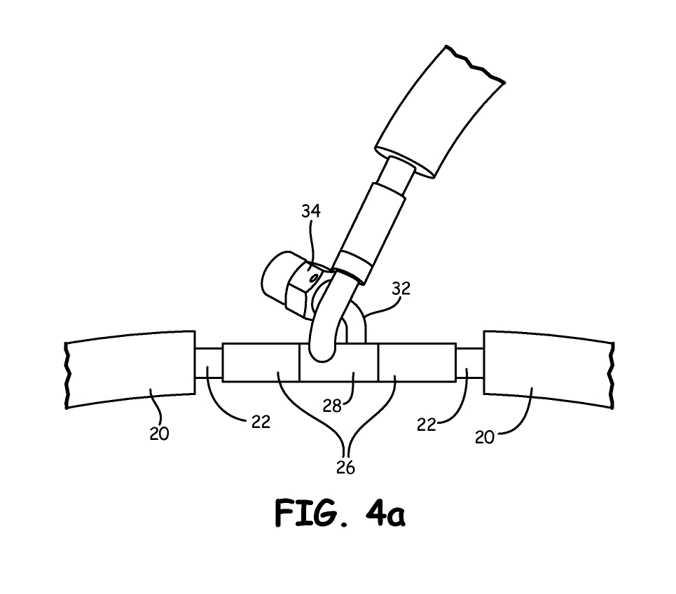

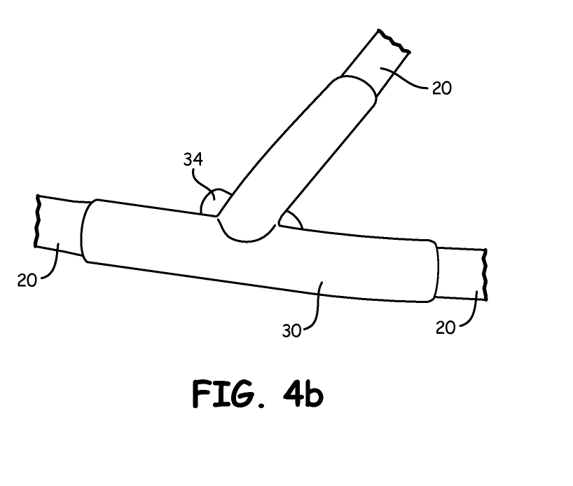

FIG. 4a is a perspective view of a portion of a fuel manifold segment of another embodiment without a cuff molded on. FIG. 4a includes first firesleeve 20 trimmed back, exposing reinforcing layer 22, crimp collar 26, hose insert 28, pigtail line 32, and connector 34. First firesleeve 20 can be integrally extruded over reinforcing layer 22. Alternately, first firesleeve 20 can be installed by sliding it over reinforcing layer 22 during the manifold assembly process. Reinforcing layer 22 is attached to hose insert 28 by crimp collar 26. Pigtail line 32 is joined to hose insert 28 and provides an internal fuel passage therethrough between fuel line and fuel injector. Connector 34 provides a connection between fuel injector inlet fitting and pigtail line 32.

When no cuff is present, as in FIG. 4a, fuel manifold fitting metal portions are exposed and in the presence of a fire may fail at a lower temperature than otherwise would be the case if fire protection was present. For this reason, a custom molded cuff is used to provide fire protection to the fuel manifold in this location.

FIG. 4b is a perspective view of the same fuel manifold segment portion of FIG. 4a, but with custom cuff 30 molded on. Cuff 30 ends at connector 34 and extends to surround a portion of first firesleeve 20. Cuff 30 is of a custom size and shape fit to the particular size fuel manifold segment it is being used on. Cuff 30 is sized and shaped to cover and fit over and around the pigtail line, the reinforcing layer and thus the fuel line to which the pigtail line is connected through the crimp collar and hose insert (all exposed and shown in FIG. 4a), and a portion of first firesleeve 20. The shape can be such that it covers the hose insert and crimp collar then extends out from the hose insert to further cover the pigtail line. Once of a size and shape so as to cover these parts of the fuel manifold segment, cuff 30 is molded into place. Cuff 30 can be made of any fire resistant material, but preferably is made of silicone rubber material.

Cuff 30 provides added fire protection to the fuel manifold segment by covering otherwise exposed reinforcing layer, crimp collar, hose insert, and pigtail line, as is shown in FIG. 4a. This added fire protection provided by cuff 30 allows the fuel manifold segment to withstand higher temperatures without failing.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fuel manifold segment for supplying fuel to a fuel injector, the fuel manifold segment comprising:
a fuel line surrounded by a first firesleeve;
a pigtail line connected to the fuel line;
a connector on the pigtail line for connecting to a fuel injector inlet fitting;
a second firesleeve surrounding the first firesleeve;
a cuff surrounds the pigtail line, a portion of the first firesleeve, and a portion of the fuel line to which the pigtail line is connected; and
a boot surrounding the connector.

2. The fuel manifold segment of claim 1 wherein the fuel line is a polytetrafluoroethylene liner.

3. The fuel manifold segment of claim 1 wherein the fuel line is surrounded by a reinforcing layer.

4. The fuel manifold segment of claim 3 wherein the reinforcing layer is a wire braid.

5. The fuel manifold segment of claim 1 wherein the first firesleeve is made of a silicone rubber material.

6. The fuel manifold segment of claim 1 wherein the second firesleeve is an AS 1072 fiberglass silicone rubber material secured in place by a metal band clamp.

7. The fuel manifold segment of claim 1 wherein the connector comprises a nut and a hydraulic fitting which mate with the fuel injector inlet fitting.

8. The fuel manifold segment of claim 1 wherein the boot is secured in place by a screw adjustable clamp such that the boot can be put in place and removed with a common tool.

9. The fuel manifold segment of claim 1 wherein the boot is made of a fiber reinforced rubber material.

10. The fuel manifold segment of claim 1 wherein the fuel manifold segment is capable of withstanding a fire at 2000° F. minimum average temperature at a very low flow rate in the fuel line for a period of at least 5 minutes.

11. A method of providing fire protection for a fuel manifold comprising:
fitting a boot around a connector on a pigtail line for connecting to a fuel injector inlet fitting; and
securing the boot in place with a clamp.

12. The method of claim 11 wherein the connector comprises a nut and a hydraulic fitting which mate with the fuel injector inlet fitting.

13. The method of claim 11 wherein the clamp is screw adjustable such that the boot can be put in place and removed with a common tool.

14. The method of claim 11 wherein the boot is a continuous cylinder.

15. The method of claim 11 further comprising:
surrounding a fuel line with a first firesleeve;
surrounding the first firesleeve with a second firesleeve; and
molding a cuff over the pigtail line, a portion of the first firesleeve, and a portion of the fuel line to which the pigtail is connected.

16. The method of claim 15 wherein the fire protection on the fuel manifold is capable of withstanding a fire at 2000° F. minimum average temperature at a very low flow rate in the fuel line for a period of at least 5 minutes.
